(19) United States
(12) Patent Application Publication
(10) Pub. No.: US 2012/0199081 A1
(43) Pub. Date: Aug. 9, 2012

(54) ANIMAL IDENTIFICATION ENTERTAINMENT AND SAFETY DEVICE

(76) Inventor: Richard Daye, Orlando, FL (US)

(21) Appl. No.: 13/020,421

(22) Filed: Feb. 3, 2011

(51) Int. Cl. A01K 29/00; A01K 27/00

(52) U.S. Cl. 119/707

(57) ABSTRACT

An animal identification entertainment and safety device acts as a play toy, an animal identifier and a movement control device. The device includes a main body having a concave bottom portion that is capable of resting on the back of an animal, the device includes attachment units for connecting to an animal collar and a leash. The device can connect only to the collar of an animal in order to act as an identification unit and to prevent a pet owner from being bitten.

### BACKGROUND

### Field of the Invention

The present invention relates generally to an animal collar attachment, and more particularly to a device capable of easily identifying an animal, while providing entertainment and safety to pet owners.

Responsible pet owners often walk their pets on a leash to local parks and other recreational areas. Upon arrival, many pet owners will unleash their animals in order to allow them to run and play with other pets. To this end, identifying a particular animal out of the crowd can often be difficult. Alternatively, a pet owner may choose to bring pet toys in order to play with the animal directly.

In some circumstances, when many pets are roaming a common area, disputes between the animals can arise. When this occurs, the pet owners must quickly intervene before injuries occur. This is typically accomplished by grabbing an animal's collar and attempting to separate it from the offending activity. However, sometimes the pet can mistake the hand of an owner as an attacker, which can result in the owner being bitten.

In light of the above, it would be beneficial to provide a single device which is capable of quickly identifying an animal, providing entertainment, and providing a safe means of controlling the movement of the animal.

### SUMMARY OF THE INVENTION

The present invention is directed to an animal identification, entertainment and safety device. One embodiment of the present invention can include a main body having a concave bottom portion that is capable of resting on the back of an animal. The device can be interposed between the collar and leash of the animal. Additionally, the device can connect only to the collar of an animal in order to act as an identification unit and to prevent a pet owner from being bitten.

Another embodiment of the present invention can include a removable strap configured to allow the device to act as an animal harness. Finally, the device can include a construction suitable for acting as a play toy for the animal.

### BRIEF DESCRIPTION OF THE DRAWINGS

Presently preferred embodiments are shown in the drawings. It should be appreciated; however, that the invention is not limited to the precise arrangements and instrumentalities shown.

FIG. 1 is a side view of an animal identification, entertainment, and safety device which is useful for understanding the inventive concepts disclosed herein.

FIG. 2 is another side view of the animal identification, entertainment, and safety device according to one embodiment of the invention.

FIG. 3 is a cross section view of the animal identification, entertainment, and safety device according to another embodiment of the invention.

FIG. 4 is a front view of the animal identification, entertainment, and safety device according to one embodiment of the invention.

FIG. 5 is a side view of the animal identification, entertainment, and safety device in action, according to one embodiment of the invention.

FIG. 6 is another side view of the animal identification, entertainment, and safety device in action, according to another embodiment of the invention.

FIG. 7 is a top view of another alternate embodiment of the animal identification, entertainment, and safety device.

### DETAILED DESCRIPTION OF THE INVENTION

While the specification concludes with claims defining the features of the invention which are regarded as novel, it is believed the invention will be better understood from a consideration of the description in conjunction with the drawings. As required, detailed embodiments of the present invention are disclosed herein; however, it is to be understood that the disclosed embodiments are merely exemplary of the invention, an invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting, but rather to provide an understandable description of the invention.

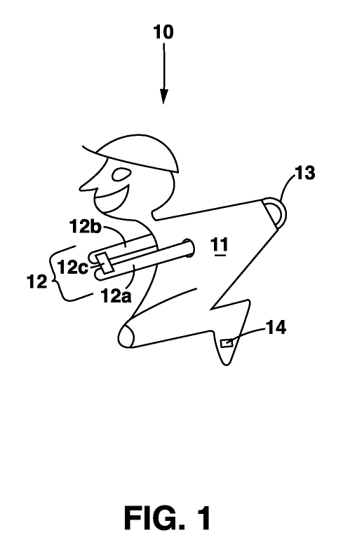

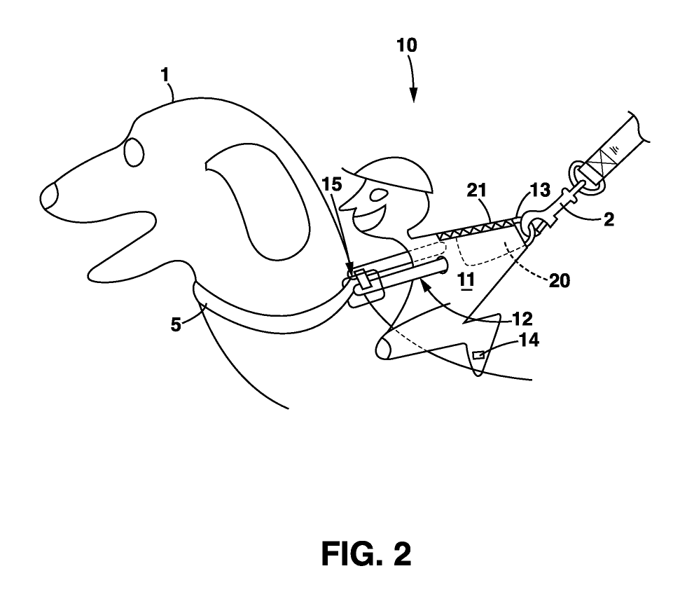

FIGS. 1 and 2 illustrate one embodiment of an animal identification, entertainment, and safety device 10 that is useful for understanding the inventive concepts disclosed herein. As shown, the main body 11 can include, for example, a distinctive and/or humorous shape such as a jockey, for example. As shown, the device 10 can act as a toy for playing fetch and can be constructed to float and/or to squeak when bitten by the animal. To this end, when not secured to an animal (as will be described below in detail), the device can function as a recreational toy for the enjoyment of both the pet and the pet owner. Although illustrated in this embodiment as a jockey, one of skill in the art will recognize that the main body 11 can take any number of different shapes and designs without deviating from the scope and spirit of the inventive concepts disclosed herein.

Additionally, device 10 further includes a front attachment unit 12 having an optional clip 15 for allowing the main body 11 to be attached to the collar 5 of an animal 1. As shown, attachment unit 12 can include two substantially parallel members 12a and 12b (i.e., arms of the jockey) secured together by a cross member 12c.

Moreover, the device can include a rear attachment unit 13 incorporating a ring, loop or other such device capable of being secured to a traditional leash 2. Further, the device 10 can also include a pair of optional lower attachment units 14 to be described below. As shown, the device 10 can be interposed between the leash 2 and the collar of the animal 5, so as to prevent a user from having to carry the device while walking the animal.

Although described above as having fixed locations, one of skill in the art will recognize that attachment units 12 and 13 can be positioned anywhere along the main body in order to suit the particular novelty shape of the device and/or the type of animal to which it is being secured.

FIG. 2 also illustrates an optional pocket 20 having an opening 21, such as a zipper, for allowing items to be stored within the main body 11. Such a feature can allow items to be stored inside the device 10 and to be carried by the animal.

As described herein, the main body 11 can be constructed from a wide variety of materials ranging, for example, from hardened rubber, neoprene, and nylon, to a stuffed cotton blend, for example. Of course other materials are also contemplated. Additionally, it is preferred that the front attachment unit be constructed from a reinforced material having excellent durability and tensile strength, such as nylon straps, plastic, or metal coated with a soft outer material. Alternatively, both attachment units and the optional clip(s) can be constructed to include, comprise, or connect with, in either a permanent or removable fashion, virtually any known means of attaching two or more items together including, but not limited to: clips, rings, compression fittings, magnetic elements, straps and rope, among many others, for example.

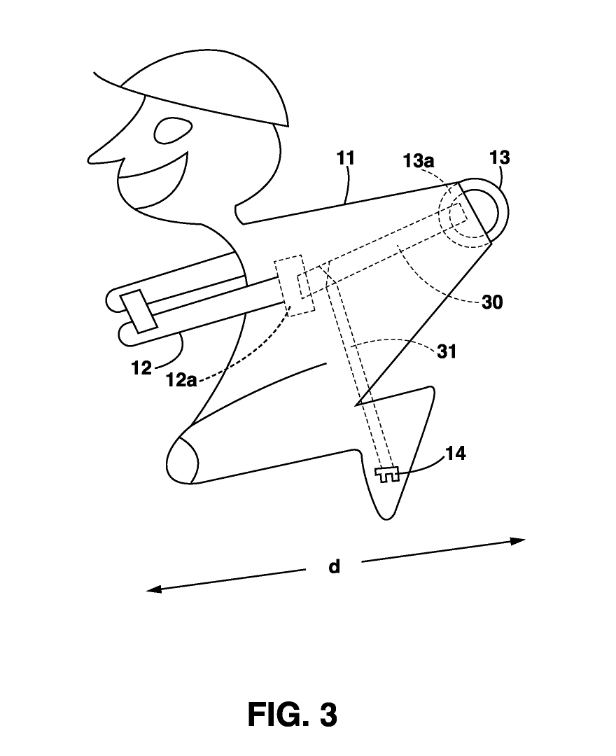

FIG. 3 illustrates one embodiment of an interior portion of the main body 11. Owing to the fact that when the device 10 is interposed between an animal 1 and a leash 2, a great amount of opposing force will be encountered by the attachment units 12 and 13. Therefore, the device 10 can include an internal support member 30 secured to the inside of both the first attachment unit 12a and the second attachment unit 13a in order to prevent the device from becoming damaged. In one preferred embodiment, the support member 30 can allow the attachment units to separate only to a distance d that can be tolerated by the material of the outer body of the device 10. As such, the support member 30 can prevent the device 10 from being ripped in half when, for instance, the animal is running in one direction and the pet owner is pulling the leash in another direction.

Additionally, in an alternate embodiment, the device 10 can also include one or more lower support members 31 connected to the internal support member 30 and each of the optional lower attachment units 14 to be described below.

As described herein, support members 30 and 31 can be constructed from a material having a strong yet flexible shape, such as a nylon tether, a metallic cord or other similar materials. Alternatively, the support members 30 and 31 can be constructed from a more rigid material such as hardened plastic, wood, metal or composite materials in order to provide strength and rigidity to the outer body 11.

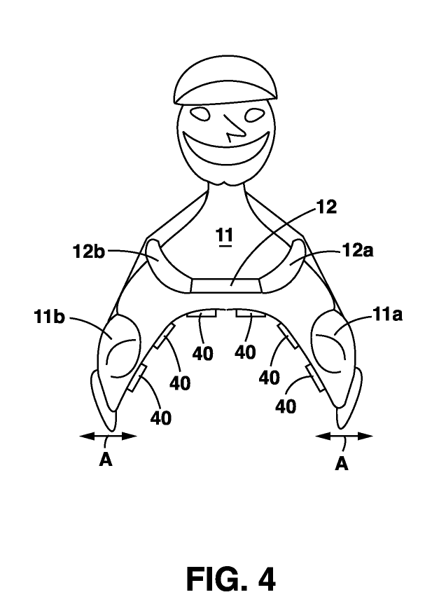

FIG. 4 illustrates one embodiment of a front view of the animal identification, entertainment, and safety device 10. As shown, the bottom side of the main body can include a concave area for allowing the device 10 to sit, or rest, on an animals' back and/or neck. Additionally, concave sides 11a and 11b (which form the legs of the jockey in this embodiment), can expand and contract to fit the varying sizes of different animals (see arrows A).

In another embodiment, optional traction units 40 can be placed within the concave area in order to allow the device 10 to “stick” to the animal itself. As used herein, traction units 40 can include any number of known materials having an extremely high coefficient of friction which when pressed against the skin or fur of an animal can act to maintain the device 10 in an upright orientation. Such materials can include, for example, rubber pads, hook and latch material (eg., VELCRO) sticky pads, adhesion tape, and other similar items.

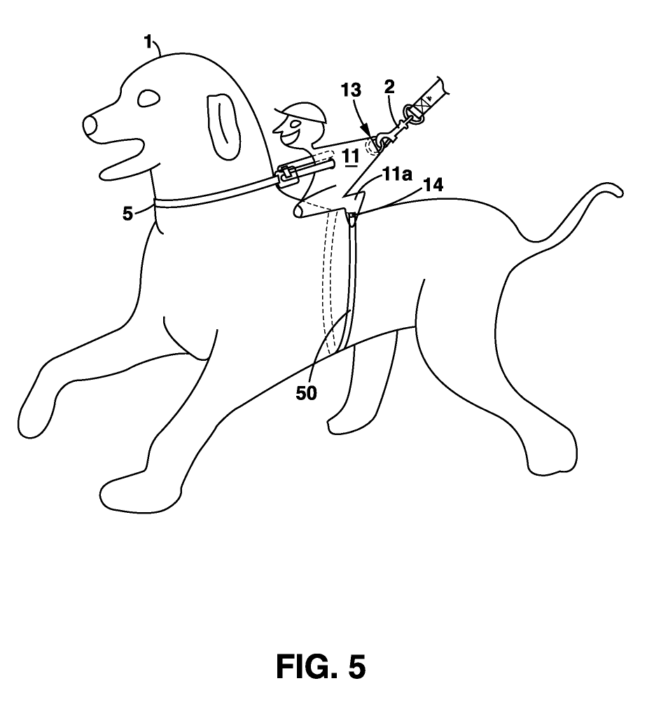

FIG. 5 illustrates an alternate embodiment of the animal identification, entertainment, and safety device 10 which further includes a pet harness 50. As shown, the pet harness can attach to the bottom sides of the main body 11a and 11b (see also FIG. 4), thus forming a loop around the body of the animal 1. In this way, the main body 11 can be securely affixed to the body of the animal so as to prevent harm to the neck when attempting to guide the animal to a particular location, or when restraining the animal. As such, by providing an additional strap around the body of the animal, it is possible (especially useful for larger dogs), to exert more control over the movements of a pet.

As described herein, the pet harness 50 can be constructed from a single piece of adjustable length material such as a nylon strap, for example, and can be removably connected to the optional lower attachment units 14 described above.

In operation, the animal identification, entertainment, and safety device 10 can be utilized for a variety of purposes. In addition to being used as a toy, backpack, leash and harness, as described above, the device 10 can remain clipped to the collar 5 of a pet in order to allow a pet owner to easily identify his or her animal in situations where many animals are present.

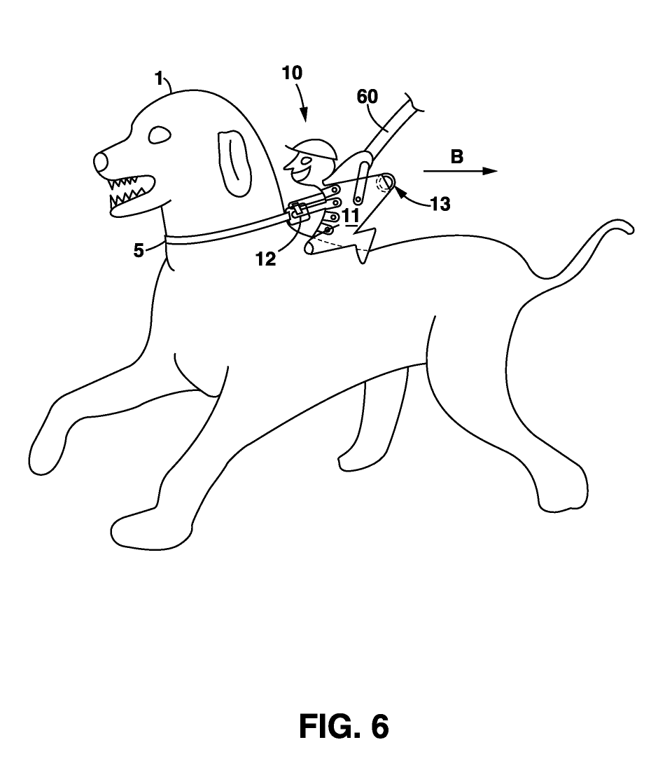

Additionally, as illustrated in FIG. 6, the device 10 can include a shape that is easily grasped by a users hand 60. To this end, the device can be used to quickly control the movements of the animal at times when a leash is not available or there is not time to acquire a leash. Moreover, by holding the device 10 instead of the collar 5, the hands of the pet owner remain out of reach of the animals mouth. Such a feature can act to prevent bites which are commonly experienced by pet owners while attempting to grab the collar of a dog that is in an agitated state.

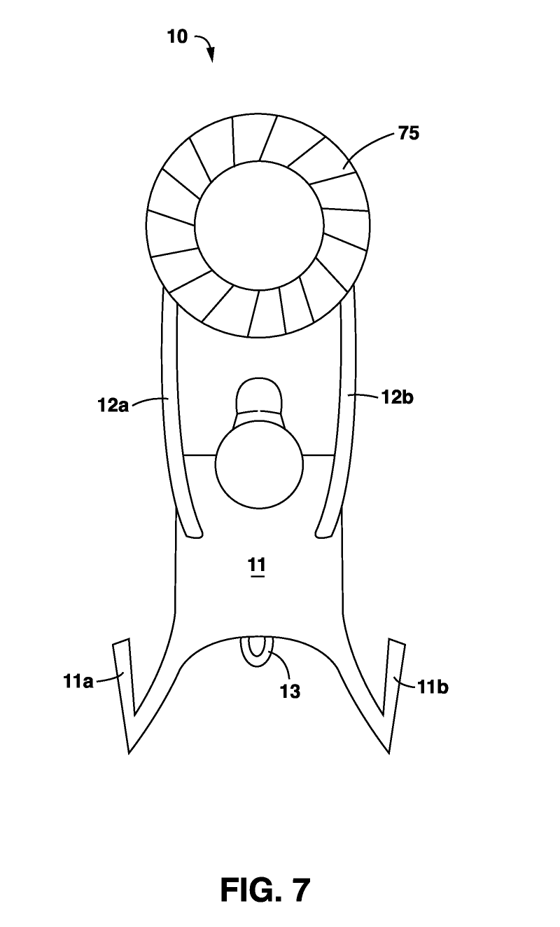

FIG. 7 illustrates another alternate embodiment of the animal identification, entertainment, and safety device 10, which further includes an integrated pet collar 75. As shown, the integrated pet collar 75 can be permanently secured to the front arms of the attachment unit 12a and 12b so as to be an integrated part of the device 10. Such a feature can allow the device to be utilized on animals without having to be secured to an existing animal collar.

In one preferred embodiment, the integrated collar 75 can be constructed from a lightweight elastic material (such as spandex or stretch fabric) that is able to expand so as to easily slip over the head of the animal and contract to a comfortable size while remaining in place. Although illustrated as encircling the animal's neck, one of skill in the art will recognize that the collar portion 75 can be constructed to only cover a portion of the animal's neck (i.e. such as a “U” clip commonly used for securing fake antlers or other such devices to an animals head). Such devices being well known in the art, no further description will be provided.

Accordingly, the animal identification, entertainment, and safety device 10, as described herein, is capable of quickly identifying an animal, providing entertainment, and providing a safe means of controlling the movement of the animal in a novel manner.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An animal identification, entertainment and safety device, comprising:
a main body having a concave bottom portion configured to rest on a back side of an animal, said concave portion having a first and second side;
a first attachment unit affixed to a front portion of the main body, said first attachment unit being configured to be removably secured to an animal collar;
a second attachment unit affixed to a back portion of the main body, said second attachment unit being configured to be removably secured to a leash; and
a primary internal support member configured to connect the first and second attachment units together, said support member being configured to prevent the first and second attachment units from achieving a separation distance that is greater than a rip tolerance of the main body.

2. The animal identification, entertainment, and safety device of claim 1, wherein said concave portion is configured to expand and contract to match a size of the animal's back.

3. The animal identification, entertainment, and safety device of claim 2, further comprising:
one or more traction units configured to secure the concave portion to the back side of the animal.

4. The animal identification, entertainment, and safety device of claim 1, wherein said main body comprises a handle configured to allow a user to direct the movements of the animal.

5. The animal identification, entertainment, and safety device of claim 4, wherein the device is further configured to prevent the animal from biting a hand of a user holding the main body.

6. The animal identification, entertainment, and safety device of claim 1, further comprising:
a pair of secondary support members secured between the primary support member and each of the first and second sides of the concave portion.

7. The animal identification, entertainment, and safety device of claim 6, further comprising:
a strap having a first end connected to the first side of the concave portion and a second end connected to the second side of the concave portion, said strap being configured to form a harness around the animal.

8. The animal identification, entertainment, and safety device of claim 1, wherein each of said first and second attachment units include at least one of a clip, ring, compression fitting, magnetic element and a strap.

9. The animal identification, entertainment, and safety device of claim 1, wherein the main body includes a novelty shape.

10. The animal identification, entertainment, and safety device of claim 9, wherein the main body includes a shape of a jockey.

11. The animal identification, entertainment, and safety device of claim 1, wherein the device is configured to act as an animal play toy when not connected to a leash and a collar.

12. The animal identification, entertainment, and safety device of claim 11, wherein the device is configured to float.

13. The animal identification, entertainment, and safety device of claim 1, wherein the device is configured to act as an animal identification unit when connected only to the animal collar.

14. The animal identification, entertainment, and safety device of claim 1, further comprising:
a pocket for transporting items, said pocket being positioned within the main body.

15. An animal identification, entertainment and safety device, comprising:
a main body having a concave bottom portion configured to rest on a back side of an animal, said concave portion having a first and second side;
a plurality of attachment units configured to secure the device to one or more external objects;
a front portion configured to be removably secured to an animal collar;
a back portion configured to be removably secured to a leash;
a strap having a first end and a second end, said first and second ends being configured to be removably attached to the first and second side of the concave portion, respectively,
wherein said strap is further configured to form a harness around a body of the animal; and
one or more internal support members configured to prevent the first and second attachment units from achieving a separation distance that is greater than a rip tolerance of the main body.

16. The animal identification, entertainment, and safety device of claim 15, wherein at least one of said plurality of attachment units includes at least one of a clip, ring, compression fitting, magnetic element and a strap.

17. The animal identification, entertainment, and safety device of claim 15, further comprising:
a pocket for transporting items, said pocket being positioned within the main body.

18. The animal identification, entertainment, and safety device of claim 15, wherein the main body includes a novelty shape.

19. An animal identification, entertainment and safety device, comprising:
a main body having a concave bottom portion configured to rest on a back side of an animal, said concave portion having a first and second side;
a collar affixed to a front portion of the main body, said collar being configured to expand and contract to fit over a head and neck of an animal;
an attachment unit affixed to a back portion of the main body, said attachment unit being configured to be removably secured to a leash; and
a primary internal support member configured to connect the collar and the second attachment unit together, said support member being configured to prevent the collar and second attachment unit from achieving a separation distance that is greater than a rip tolerance of the main body.

20. The animal identification, entertainment, and safety device of claim 19, further comprising:
a strap having a first end connected to the first side of the concave portion and a second end connected to the second side of the concave portion, said strap being configured to form a harness around the animal.
